(19) United States
(12) Patent Application Publication
(10) Pub. No.: US 2013/0279379 A1
(43) Pub. Date: Oct. 24, 2013

(54) SYSTEMS AND METHODS FOR WIRELESS COMMUNICATION OF LONG DATA UNITS

(71) Applicant: QUALCOMM INCORPORATED, San Diego, CA (US)

(72) Inventors: Lin Yang, San Diego, CA (US); Sameer Vermani, San Diego, CA (US); Santosh Paul Abraham, San Diego, CA (US)

(73) Assignee: QUALCOMM Incorporated, San Diego, CA (US)

(21) Appl. No.: 13/752,775

(22) Filed: Jan. 29, 2013

Related U.S. Application Data
(60) Provisional application No. 61/637,388, filed on Apr. 24, 2012.

(51) Int. Cl. H04W 40/00

(52) U.S. Cl. CPC H04W 40/00
USPC 370/310

(57) ABSTRACT

Systems and methods for communicating the length of a data unit and determining control data based thereon are described herein. In some aspects, a processor and a transmitter are provided. The processor may be configured to determine a measurement unit for representing the length of a data unit, the data unit including a midamble, the measurement unit being at least one of bytes or symbols. The processor may further generate a value indicating the length of the data unit based at least in part on the unit, an encoding scheme associated with the data unit, and a guard interval associated with the data unit. The generated value may be included in the data unit. The transmitter may be configured to transmit via wireless network the data unit to one or more devices.

### CROSS REFERENCE TO RELATED APPLICATION

This application claims benefit of priority under 35 U.S.C. §119(e) to U.S. Provisional Patent Application 61/637,388 entitled “SYSTEMS AND METHODS FOR WIRELESS COMMUNICATION OF LONG DATA UNITS” filed on Apr. 24, 2012, the disclosure of which is hereby incorporated by reference in its entirety.

### BACKGROUND

1. Field

The present application relates generally to wireless communications, and more specifically to systems, methods, and devices for communicating long data units. Certain aspects herein relate to data units including one or more training fields interposed between a plurality of data symbols and how to accurately determine, indicate, and/or identify the length of data units including the same.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between each other. The information may comprise packets, which in some aspects may be referred to as data units. The packets may include overhead information (e.g., header information, packet properties, etc.) that helps in routing the packet through the network, identifying the data in the packet, processing the packet, etc., as well as data, for example user data, multimedia content, etc. as might be carried in a payload of the packet.

After a packet is received, one or more portions of the packet may be decoded to determine or extract the control information or data carried in the packet. One aspect that may be considered during decoding is the length of the packet. The packet length may also be used to control the transmission and or reception of data. Thus, improved systems, methods, and devices for communicating the length and determining control data based thereon are desired.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved approaches for communicating long data packets.

One aspect of the disclosure provides a method for wireless communication. The method includes determining, with a processor, a measurement unit for representing the length of a data unit, the data unit including a midamble, the measurement unit being at least one of bytes or symbols. The method includes generating a value indicating the length of the data unit based at least in part on the measurement unit and an encoding scheme associated with the data unit. The method also provides including the generated value in the data unit. The method further includes transmitting via wireless network the data unit to one or more devices.

Another aspect of the disclosure provides another method for wireless communication. The method includes receiving via wireless network a data unit including a midamble, a first value indicating a measurement unit for representing the length of the data unit, and a second value indicating a length for the data unit. The method also includes processing the data unit based at least in part on the first value, the second value, and an encoding scheme associated with the data unit.

In a further innovative aspect, an apparatus for wireless communication is provided. The apparatus includes a determining circuit configured to determine a measurement unit for representing the length of a data unit, the data unit including a midamble, the measurement unit being at least one of bytes or symbols. The apparatus includes a length generator circuit configured to generate a value indicating the length of the data unit based at least in part on the unit and an encoding scheme associated with the data unit. The apparatus includes a data unit generator circuit configured to include the generated value in the data unit. The apparatus includes a transmitter configured to transmit via wireless network the data unit to one or more devices.

In a further innovative aspect, another apparatus for wireless communication is provided. The apparatus includes a receiver configured to receive via wireless network a data unit including a midamble, a first value indicating a measurement unit for representing the length of the data unit, and a second value indicating a length for the data unit. The apparatus also includes a processor configured process the data unit based at least in part on the first value, the second value, and an encoding scheme associated with the data unit.

A further apparatus for wireless communication is provided in an additional innovative aspect. The apparatus includes means for determining a measurement unit for representing the length of a data unit, the data unit including a midamble, the measurement unit being at least one of bytes or symbols. The apparatus includes means for generating a value indicating the length of the data unit based at least in part on the measurement unit and an encoding scheme associated with the data unit. The apparatus includes means for including the generated value in the data unit. The apparatus includes means for transmitting via wireless network the data unit to one or more devices.

In one innovative aspect, another wireless communication apparatus is provided. The apparatus includes means for receiving via wireless network a data unit including a midamble, a first value indicating a measurement unit for representing the length of the data unit, and a second value indicating a length for the data unit. The apparatus further includes means for processing the data unit based at least in part on the first value, the second value, and an encoding scheme associated with the data unit.

In a further innovative aspect, a computer-readable storage medium including instructions executable by a processor of an apparatus are provided. The instructions cause the apparatus to determine a measurement unit for representing the length of a data unit, the data unit including a midamble, the measurement unit being at least one of bytes or symbols. The instructions cause the apparatus to generate a value indicating the length of the data unit based at least in part on the measurement unit and an encoding scheme associated with the data unit. The instructions cause the apparatus to include the generated value in the data unit. The instructions cause the apparatus to transmit via wireless network the data unit to one or more devices.

In another innovative aspect, a computer-readable storage medium including instructions executable by a processor of an apparatus are provided. The instructions cause the apparatus to receive via wireless network a data unit including a midamble, a first value indicating a measurement unit for representing the length of the data unit, and a second value indicating a length for the data unit. The instructions cause the apparatus to process the data unit based at least in part on the first value, the second value, and an encoding scheme associated with the data unit.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 illustrates various components that may be utilized in the wireless device of FIG. 2 to transmit wireless communications.

FIG. 4 illustrates various components that may be utilized in the wireless device of FIG. 2 to receive wireless communications.

FIG. 5 is a functional block diagram of an exemplary MIMO system that may be implemented in wireless devices such as the wireless device of FIG. 2 to transmit wireless communications.

FIG. 6 is a functional block diagram of an exemplary MIMO system that may be implemented in wireless devices such as the wireless device of FIG. 2 to receive wireless communications.

FIG. 7 is a block diagram showing an exemplary structure of a preamble and payload of a physical layer packet.

FIG. 8 illustrates a process flow diagram of a method of indicating length of a data unit.

FIG. 9 illustrates a process flow diagram of another method of indicating length of a data unit.

FIG. 10 illustrates a process flow diagram of a further method of indicating length of a data unit.

FIG. 11 illustrates a process flow diagram of another method of indicating length of a data unit.

FIG. 12 is a process flow diagram illustrating a method of communicating in a wireless communication system.

FIG. 13 illustrates a functional block diagram of an example wireless device.

FIG. 14 is a process flow diagram illustrating a method of communicating in a wireless communication system.

FIG. 15 illustrates a functional block diagram of another example wireless device.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. For example, the various aspects described herein may be used as part of the IEEE 802.11ah protocol, which uses sub-1 GHz bands.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

Certain of the devices described herein may further implement Multiple Input Multiple Output (MIMO) technology and be implemented as part of the 802.11ah standard. A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels or streams, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices which are the components that access the wireless network. For example, there may be two types of devices: access points (“APs”) and clients (also referred to as stations, or “STAB”). In general, an AP serves as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement the 802.11ah standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

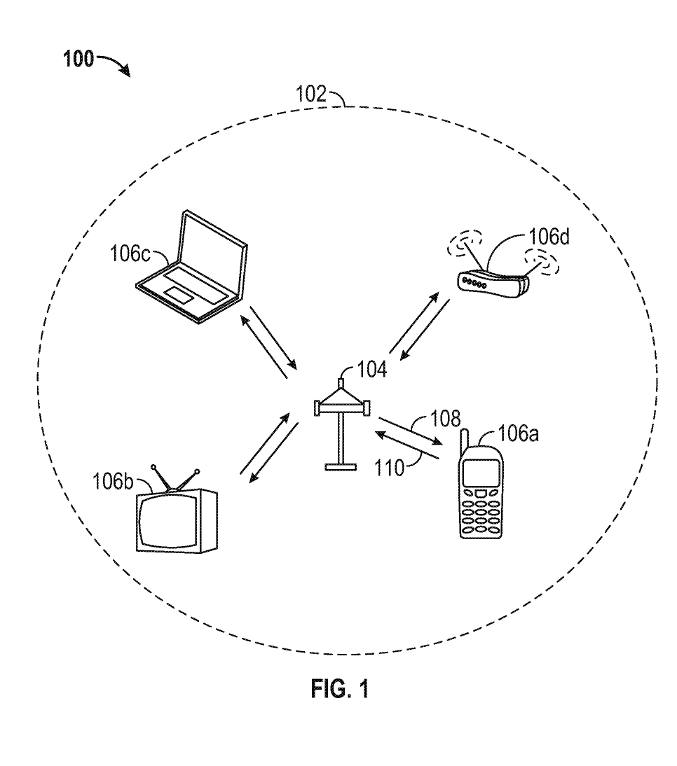

FIG. 1 illustrates an example of a wireless communication system 100 in which aspects of the present disclosure may be employed. The wireless communication system 100 may operate pursuant to a wireless standard, for example the 802.11ah standard. The wireless communication system 100 may include an AP 104, which communicates with STAs 106a, 106b, 106c, 106d (collectively STAs 106).

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

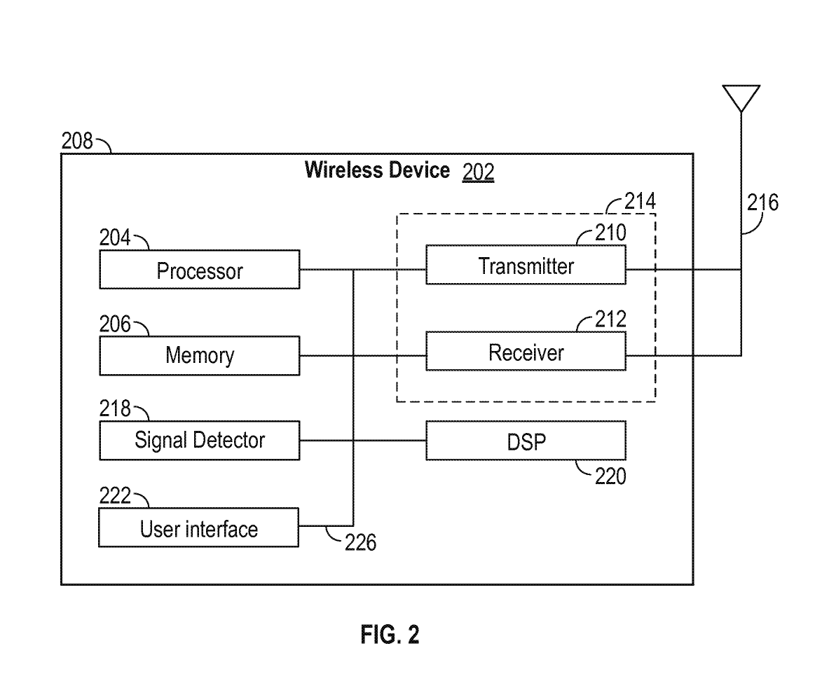

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the AP 104 or one of the STAs 106 of FIG. 1.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements. Furthermore, the processor 204 may be used to implement any of the components, modules, circuits, or the like described, or each may be implemented using a plurality of separate elements.

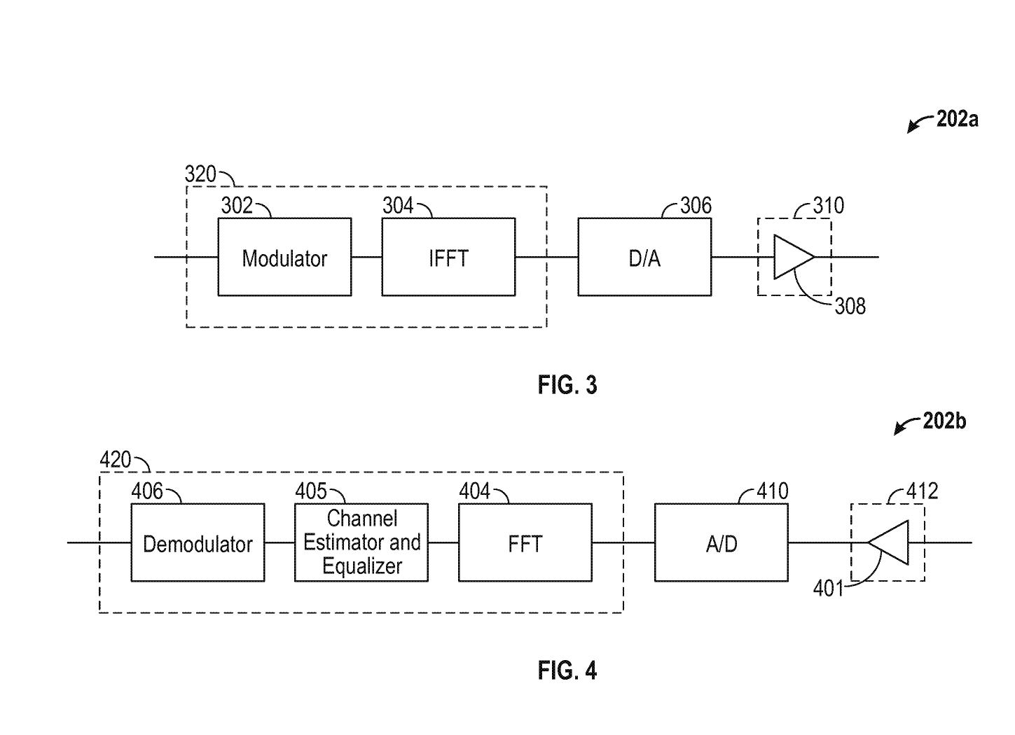

As discussed above, the wireless device 202 may comprise an AP 104 or an STA 106, and may be used to transmit and/or receive communications. FIG. 3 illustrates various components that may be utilized in the wireless device 202 to transmit wireless communications. The components illustrated in FIG. 3 may be used, for example, to transmit OFDM communications. In some aspects, the components illustrated in FIG. 3 are used to transmit data units that are temporally long and/or that include one or more training fields interposed between a plurality of data symbols, as will be discussed in additional detail below.

The wireless device 202a of FIG. 3 may comprise a modulator 302 configured to modulate bits for transmission. For example, the modulator 302 may determine a plurality of symbols from bits received from the processor 204 (FIG. 2) or the user interface 222 (FIG. 2), for example by mapping bits to a plurality of symbols according to a constellation. The bits may correspond to user data or to control information. In some aspects, the bits are received in codewords. In one aspect, the modulator 302 comprises a QAM (quadrature amplitude modulation) modulator, for example a 16-QAM modulator or a 64-QAM modulator. In other aspects, the modulator 302 comprises a binary phase-shift keying (BPSK) modulator or a quadrature phase-shift keying (QPSK) modulator.

The wireless device 202a may further comprise a transform module 304 configured to convert symbols or otherwise modulated bits from the modulator 302 into a time domain. In FIG. 3, the transform module 304 is illustrated as being implemented by an inverse fast Fourier transform (IFFT) module. In some implementations, there may be multiple transform modules (not shown) that transform units of data of different sizes. In some implementations, the transform module 304 may be itself configured to transform units of data of different sizes. For example, the transform module 304 may be configured with a plurality of modes, and may use a different number of points to convert the symbols in each mode. For example, the IFFT may have a mode where 32 points are used to convert symbols being transmitted over 32 tones (i.e., subcarriers) into a time domain, and a mode where 64 points are used to convert symbols being transmitted over 64 tones into a time domain. The number of points used by the transform module 304 may be referred to as the size of the transform module 304.

In FIG. 3, the modulator 302 and the transform module 304 are illustrated as being implemented in the DSP 320. In some aspects, however, one or both of the modulator 302 and the transform module 304 are implemented in the processor 204 or in another element of the wireless device 202 (e.g., see description above with reference to FIG. 2).

As discussed above, the DSP 320 may be configured to generate a data unit for transmission. In some aspects, the modulator 302 and the transform module 304 may be configured to generate a data unit comprising a plurality of fields including control information and a plurality of data symbols. The fields including the control information may comprise one or more training fields, for example, and one or more signal (SIG) fields. Each of the training fields may include a known sequence of bits or symbols. Each of the SIG fields may include information about the data unit, for example a description of a length or data rate of the data unit.

In some aspects, the DSP 320 is configured to insert one or more training fields between a plurality of data symbols. The DSP 320 may determine a position or location of the one or more training fields in the data unit based on information received from the processor 204 (FIG. 2), and/or stored in the memory 206 (FIG. 2) or in a portion of the DSP 320. Inserting the training fields in the data unit will be discussed in additional detail.

Returning to the description of FIG. 3, the wireless device 202a may further comprise a digital to analog converter 306 configured to convert the output of the transform module into an analog signal. For example, the time-domain output of the transform module 306 may be converted to a baseband OFDM signal by the digital to analog converter 306. The digital to analog converter 306 may be implemented in the processor 204 or in another element of the wireless device 202 of FIG. 2. In some aspects, the digital to analog converter 306 is implemented in the transceiver 214 (FIG. 2) or in a data transmit processor.

The analog signal may be wirelessly transmitted by the transmitter 310. The analog signal may be further processed before being transmitted by the transmitter 310, for example by being filtered or by being upconverted to an intermediate or carrier frequency. In the aspect illustrated in FIG. 3, the transmitter 310 includes a transmit amplifier 308. Prior to being transmit, the analog signal may be amplified by the transmit amplifier 308. In some aspects, the amplifier 308 comprises a low noise amplifier (LNA).

The transmitter 310 is configured to transmit one or more packets or data units in a wireless signal based on the analog signal. The data units may be generated using the processor 204 (FIG. 2) and/or the DSP 320, for example using the modulator 302 and the transform module 304 as discussed above. Data units that may be generated and transmitted as discussed above are described in additional detail below.

In some aspects, the transmitter 310 is configured to transmit the data units over a bandwidth of approximately 2.5 MHz or 1.25 MHz, or lower. When using such bandwidths, transmission of the data unit may be performed over a relatively lengthy period of time. For example, a data unit composed of 500 bytes or octets may be transmitted over a period of approximately 11 milliseconds. Such transmission is approximately sixteen times slower than comparable transmissions implemented pursuant to the 802.11ac standard over bandwidths of approximately 20 MHz.

FIG. 4 illustrates various components that may be utilized in the wireless device 202 of FIG. 2 to receive wireless communications. The components illustrated in FIG. 4 may be used, for example, to receive OFDM communications. In some aspects, the components illustrated in FIG. 4 are used to receive data units that are temporally long and/or that include one or more training fields interposed between a plurality of data symbols, as will be discussed in additional detail below. For example, the components illustrated in FIG. 4 may be used to receive data units transmitted by the components discussed above with respect to FIG. 3.

The receiver 412 of wireless device 202b is configured to receive one or more packets or data units in a wireless signal. Data units that may be received and decoded or otherwise processed as discussed below are described in additional detail below.

In some aspects, the receiver 412 is configured to receive the data units over a bandwidth of approximately 2.5 MHz or 1.25 MHz, or lower. When using such bandwidths, reception of the data unit may be performed over a relatively lengthy period of time, for example approximately 11 milliseconds when the data unit is composed of 500 bytes. During this time, the channel over which the data unit is received may be changing. For example, conditions of the channel may change due to movement of the wireless device 202b or of a device transmitting the data unit, or due to weather or other environmental conditions such as the introduction of various obstacles. In such circumstances, information near the end of the data unit may not be correctly decoded if the wireless device 202b uses settings determined when reception of the data unit began. As described in additional detail below, however, the wireless device 202b may use the training fields interposed between the plurality of data symbols to form an updated estimate of the channel in order to properly decode one or more of the data symbols.

In the aspect illustrated in FIG. 4, the receiver 412 includes a receive amplifier 401. The receive amplifier 401 may be configured to amplify the wireless signal received by the receiver 412. In some aspects, the receiver 412 is configured to adjust the gain of the receive amplifier 401 using an automatic gain control (AGC) procedure. In some aspects, the automatic gain control uses information in one or more received training fields, such as a received short training field (STF), for example, to adjust the gain. Those having ordinary skill in the art will understand methods for performing AGC. In some aspects, the amplifier 401 comprises an LNA.

The wireless device 202b may comprise an analog to digital converter 410 configured to convert the amplified wireless signal from the receiver 410 into a digital representation thereof. Further to being amplified, the wireless signal may be processed before being converted by the digital to analog converter 410, for example by being filtered or by being downconverted to an intermediate or baseband frequency. The analog to digital converter 410 may be implemented in the processor 204 or in another element of the wireless device 202 (FIG. 2). In some aspects, the analog to digital converter 410 is implemented in a transceiver or in a data receive processor.

The wireless device 202b may further comprise a transform module 404 configured to convert the representation of the wireless signal into a frequency spectrum. In FIG. 4, the transform module 404 is illustrated as being implemented by a fast Fourier transform (FFT) module. In some aspects, the transform module may identify a symbol for each point that it uses. As described above with reference to FIG. 3, the transform module 404 may be configured with a plurality of modes, and may use a different number of points to convert the signal in each mode. For example, the transform module 404 may have a mode where 32 points are used to convert a signal received over 32 tones into a frequency spectrum, and a mode where 64 points are used to convert a signal received over 64 tones into a frequency spectrum. The number of points used by the transform module 404 may be referred to as the size of the transform module 404. In some aspects, the transform module 404 may identify a symbol for each point that it uses.

The wireless device 202b may further comprise a channel estimator and equalizer 405 configured to form an estimate of the channel over which the data unit is received, and to remove certain effects of the channel based on the channel estimate. For example, the channel estimator may be configured to approximate a function of the channel, and the channel equalizer may be configured to apply an inverse of that function to the data in the frequency spectrum.

In some aspects, the channel estimator and equalizer 405 uses information in one or more received training fields, such as a long training field (LTF) for example, to estimate the channel. The channel estimate may be formed based on one or more LTFs received at the beginning of the data unit. This channel estimate may thereafter be used to equalize data symbols that follow the one or more LTFs. After a certain period of time or after a certain number of data symbols, one or more additional LTFs may be received in the data unit. The channel estimate may be updated or a new estimate formed using the additional LTFs. This new or updated channel estimate may be used to equalize data symbols that follow the additional LTFs. In some aspects, the new or updated channel estimate is used to re-equalize data symbols preceding the additional LTFs. Those having ordinary skill in the art will understand methods for forming a channel estimate.

The wireless device 202b may further comprise a demodulator 406 configured to demodulate the equalized data. For example, the demodulator 406 may determine a plurality of bits from symbols output by the transform module 404 and the channel estimator and equalizer 405, for example by reversing a mapping of bits to a symbol in a constellation. The bits may be processed or evaluated by the processor 204 (FIG. 2), or used to display or otherwise output information to the user interface 222 (FIG. 2). In this way, data and/or information may be decoded. In some aspects, the bits correspond to codewords. In one aspect, the demodulator 406 comprises a QAM (quadrature amplitude modulation) demodulator, for example a 16-QAM demodulator or a 64-QAM demodulator. In other aspects, the demodulator 406 comprises a binary phase-shift keying (BPSK) demodulator or a quadrature phase-shift keying (QPSK) demodulator.

In FIG. 4, the transform module 404, the channel estimator and equalizer 405, and the demodulator 406 are illustrated as being implemented in the DSP 420. In some aspects, however, one or more of the transform module 404, the channel estimator and equalizer 405, and the demodulator 406 are implemented in the processor 204 or in another element of the wireless device 202 (e.g., see description above with reference to FIG. 2).

As discussed above, the wireless signal received at the receiver 412 comprises one or more data units. Using the functions or components described above, the data units or data symbols therein may be decoded evaluated or otherwise evaluated or processed. For example, the processor 204 (FIG. 2) and/or the DSP 420 may be used to decode data symbols in the data units using the transform module 404, the channel estimator and equalizer 405, and the demodulator 406.

Data units exchanged by the AP 104 and the STA 106 may include control information or data, as discussed above. At the physical (PHY) layer, these data units may be referred to as physical layer protocol data units (PPDUs). In some aspects, a PPDU may be referred to as a packet or physical layer packet. Each PPDU may comprise a preamble and a payload. The preamble may include training fields and a SIG field. The payload may comprise a Media Access Control (MAC) header or data for other layers, and/or user data, for example. The payload may be transmitted using one or more data symbols. The systems, methods, and devices herein may utilize data units with training fields that are also interposed between data symbols in the payload.

The wireless device 202a shown in FIG. 3 shows an example of a single transmit chain to be transmitted over an antenna. The wireless device 202b shown in FIG. 4 shows an example of a single receive chain to be received over an antenna. In some implementations, the wireless devices 202a and 202b may implement a portion of a MIMO system using multiple antennas to simultaneously transmit data.

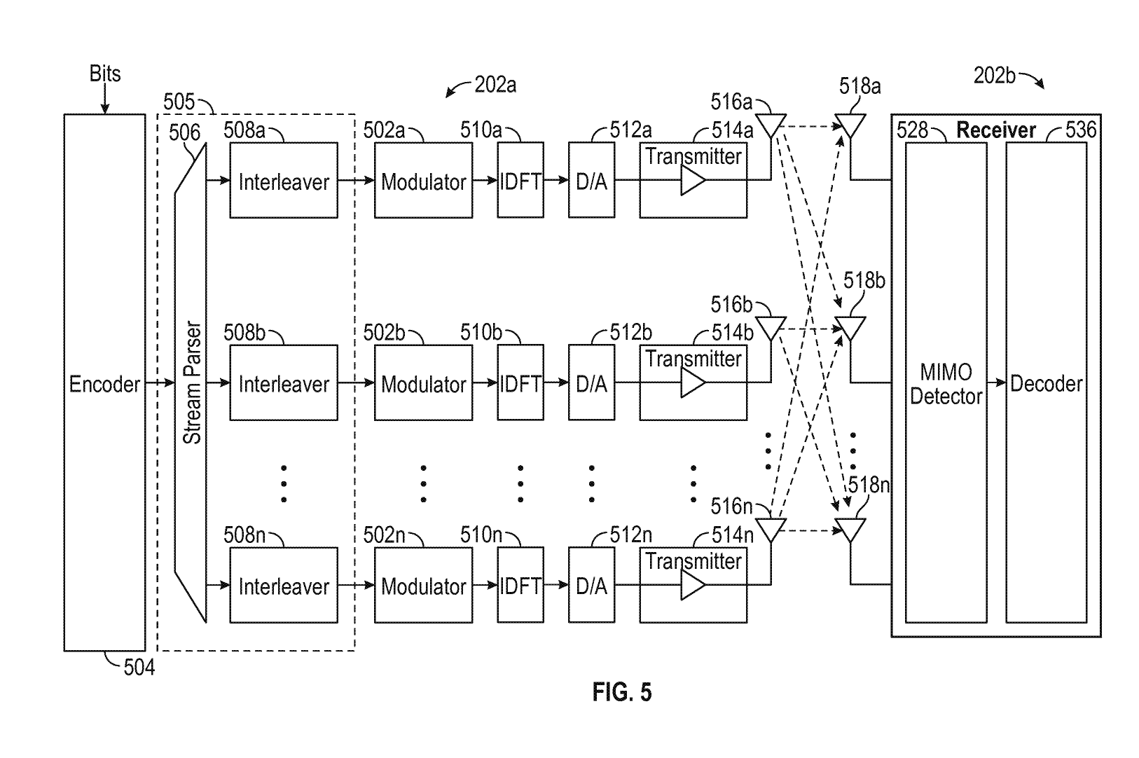

FIG. 5 is a functional block diagram of a MIMO system that may be implemented in wireless devices such as the wireless device 202 of FIG. 2 to transmit and receive wireless communications. The MIMO system may make use of some or all of the components described with reference to FIG. 3. Bits for transmission that are to be received at an output of the receiver are provided to an encoder 504. The encoder 504 may apply a forward error correcting (FEC) code on the bit stream. The FEC code may be a block code, a convolution code, or the like. The encoded bits are provided to an interleaving system 505 that distributes the encoded bits into N transmit streams.

The interleaving system 505 includes a stream parser 506 that parses an input bit stream from the encoder 504 to N spatial stream interleavers 508a, 508b, and 508n. The stream parser 506 may be provided with the number of spatial streams and parse bits on a round-robin basis. Other parsing functions may also be used. One parsing function that may be used is kₙ=N_{TX}*k+n (i.e., round-robin with one bit per spatial stream, then on to the next spatial stream where kₙ is the input bit index and N_{TX} is the number of transmitters/spatial streams). Another more general function f(k,n) may also be used, for example, sending two bits to a spatial stream, then moving on to the next spatial stream. Each interleaver 508a, 508b, and 508n may each thereafter distribute bits so that errors may be recovered due to fading or other channel conditions. Hereinafter the interleavers 508a, 508b, and 508n may be referred to an interleaver 508.

Each transmit stream may then be modulated by a modulator 502a, 502b, or 502n. As described above with reference to FIG. 3, the bits may be modulated using modulation techniques such as QPSK (Quaternary Phase Shift Keying) modulation, BPSK (mapping one bit at a time), 16-QAM (mapping group of six bits), 64-QAM, and the like. The modulated bits for each stream may be provided to transform modules 510a, 510b, and 510n. In some implementations, the transform modules 510a, 510b, and 510n may perform an inverse discrete time Fourier transform (IDFT) to convert the modulated bits from a frequency domain into a time domain. The transform modules 510a, 510b, and 510n may operate according to different modes as described above with reference to FIG. 3. For example, the transform modules 510a, 510b, and 510n may be configured to operate according to a 32 point mode or a 64 point mode. In some implementations, the modulated bits may be encoded using space time block coding (STBC) and spatial mapping may be performed before being provided to transform modules 510a, 510b, and 510n. After the modulated bits have been converted into time domain signals for each spatial stream, the time domain signal may be converted into an analog signal via converters 512a, 512b, and 512n as described above with reference to FIG. 3. The signals may then be transmitted using transmitters 514a, 514b, and 514c and using antennas 516a, 516b, or 516n, into a wireless radio space over a desired frequency bandwidth (e.g., 1 MHz, 2 MHz, 4 MHz, 8 MHz, and 16 MHz, or higher).

In some embodiments, antennas 516a, 516b, and 516n are distinct and spatially separated antennas. In other embodiments, distinct signals may be combined into different polarizations off of fewer than N antennas. An example of this is where spatial rotation or spatial spreading is done and multiple spatial streams are mapped on a single antenna. Further, it should be understood that distinct spatial streams can be organized in different manners. For example, a transmit antenna may carry data from more than one spatial stream or several transmit antennas may carry data from a spatial stream. For example, consider the case of a transmitter with four transmit antennas and two spatial streams. Each spatial stream can be mapped onto two transmit antennas, so two antennas are carrying data from just one spatial stream.

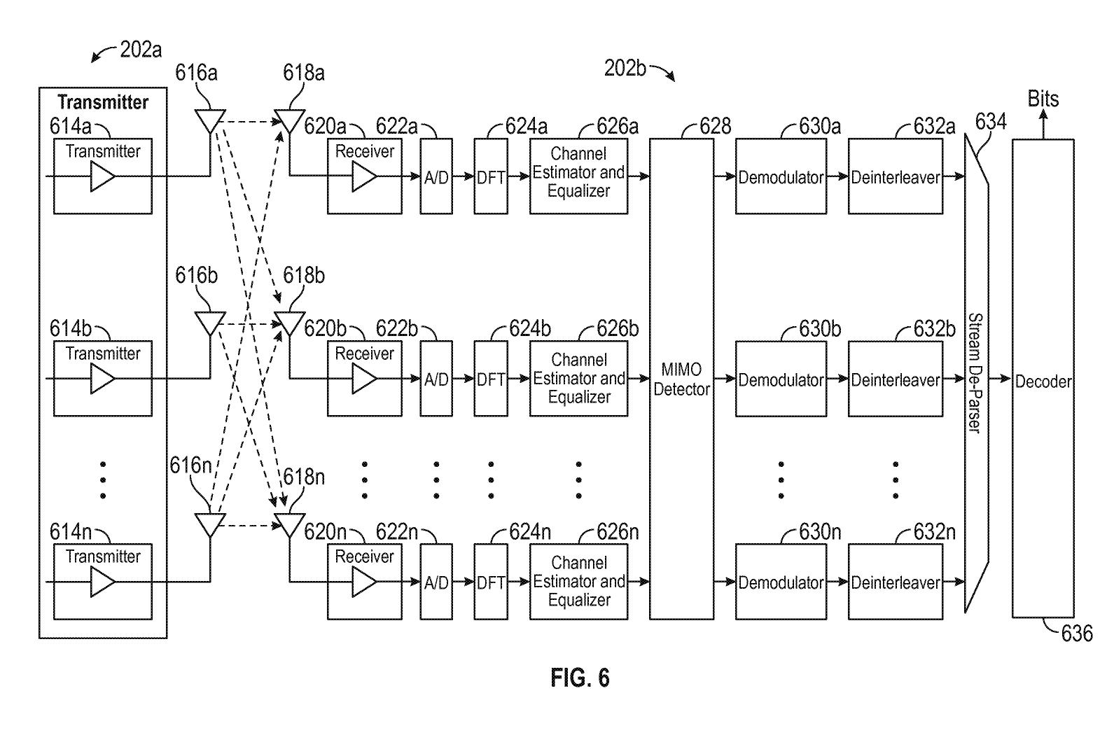

FIG. 6 is a functional block diagram of an exemplary MIMO system that may be implemented in wireless devices such as the wireless device 202 of FIG. 2 to receive wireless communications. The MIMO system may make use of some or all of the components described with reference to FIG. 4. The wireless device 202b may be configured to receive transmissions from the antennas 516a, 516b, and 516n of FIG. 5. A wireless device 202b receives signals from the channel at N antennas 518a, 518b, and 518n or 618a, 618b, and 618n (counting separate polarizations, as appropriate) coupled to N receive circuits. The signals are then provided to receivers 620a, 620b, and 620n that each may include an amplifier configured to amplify the received signals. The signals may then be converted into a digital form via converters 622a, 622b, and 622n.

Converted signals may then be converted into a frequency spectrum via transform modules 624a, 624b, and 624n. As described above, the transform modules 624a, 624b, and 624n may operate according to various modes and according to the size and bandwidth used (e.g., 32 point 64 point, etc.). The transformed signals may be provided to respective channel estimator and equalizer blocks 626a, 626b, and 626n that may function similarly as described above with reference to FIG. 4. After channel estimation, the outputs may be provided to a MIMO detector 628 (e.g., corresponding to MIMO detector 528 of FIG. 5) which may thereafter provide its output to demodulators 630a, 630b, and 630n which may demodulate the bits according to one of the modulation techniques as described above. Demodulated bits may then be provided to deinterleavers 632a, 632b, and 632n which may pass bits into a stream de-parser 634 which may provide the bits into a single bit stream into a decoder 636 (e.g., corresponding to decoder 536 of FIG. 5) that may decode the bits into an appropriate data stream.

As described above, data units exchanged by the AP 104 and the STA 106 may include control information or data in the form of physical (PHY) layer packets or physical layer protocol data units (PPDUs).

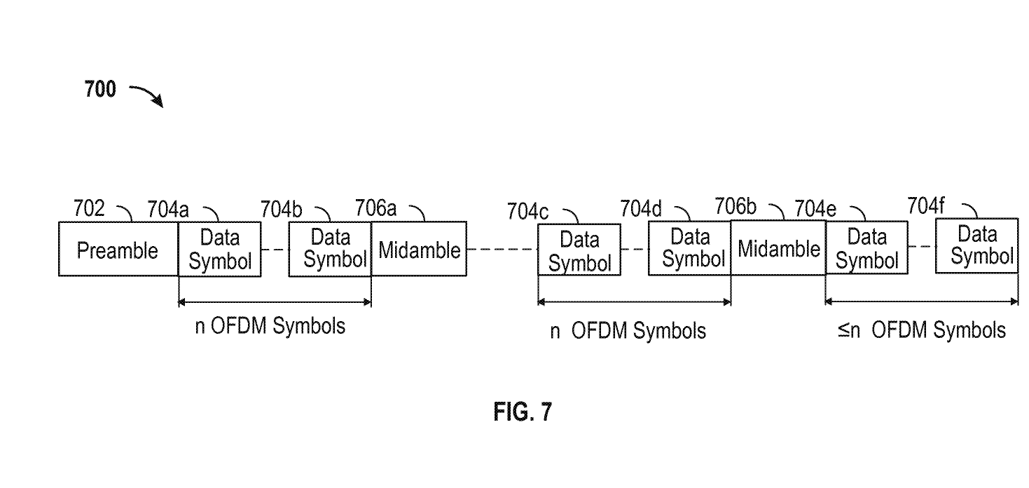

FIG. 7 illustrates an example data unit 700. The data unit 700 may comprise a PPDU for use with the wireless device 202 of FIG. 2. The data unit 700 comprises a preamble 702, a series of groups of n data symbols followed by a midamble, and a final group of data symbols. As illustrated, the first group of n data symbols includes data symbols 704a and 704b and is followed by midamble 706a. Although not illustrated, midamble 706a may be followed by many additional groups of n data symbols followed by a midamble. The additional groups of n data symbols followed by a midamble may include for instance the illustrated group of data symbols, including data symbols 704c and 704d followed by midamble 706b. The final group of data symbols, including data symbols 704e and 704f, may include n or fewer data symbols and may not be followed by a midamble.

The preamble 702 may include fields such as a short training field (STF), a long training field (LTF), a legacy long training field (L-LTF), a signaling (SIG) field, a legacy SIG (L-SIG) field. The preamble 702 may further include fields such as very high throughput (VHT) short training field SIG field.

The midambles 706a and 706b of data unit 700 may include one or more training fields. For example, the midambles 706a and 706b may each include one L-LTF. As another example, the midambles 706a and 706b may each include one STF, such as VHT STF, and two LTFs, such as a VHT LTF. Each repeating pairing or set of training fields (e.g., midamble) may be repeated every n data symbols. The value of n may be known or may vary.

The wireless device 202b (FIG. 4) may perform automatic gain control to adjust the gain of the receive amplifier 401 (FIG. 4) after reception of each STF included in a midamble. Further, the wireless device 202b may form new or updated channel estimates after reception of each set of LTFs included in a midamble. As a result, advantageously the data symbols of the data unit 700 may be properly decoded, even when the data unit 700 is long and the conditions of the channel are changing.

As described above, the data unit 700 may have a variable length. The length may vary based on the inclusion of midambles. For example, in some implementations, midambles may not be included in the data unit 700. The length may vary based on the number of data symbols or midambles included in the data unit 700. The length may vary based on the size of any data symbol or midambles included in the data unit 700.

In some implementations, one or more SIG fields included in the preamble 702 may be used to transmit information that can be used to identify the length of the data unit. Table 1 below describes example entries that may be included in one or more SIG fields.

TABLE 1

| Field | Bits | Description |
|---|---|---|
| Bandwidth | 2 | This may indicate a bandwidth mode (e.g., 2 |
| | | MHz, 4 MHz, 8 MHz, or 16 MHz) |
| Reserved | 1 | |
| Space Time | 1 | Indicates whether Space Time Block Coding is |
| Block Coding | | used |
| Nsts/GID/AID | 14 | For Single User (SU) Mode - 2 bits may indicate |
| | | Nsts, 0-12 bits may indicate partial AID |
| | | For Multi User (MU) Mode - 8 bits may indicate |
| | | Nsts, 6 bit GID |
| Reserved | 1 | |
| Short Guard | 1 | |
| Interval (SGI) | | |
| Coding | 2 | 1^{st} bit may indicate a coding type for SU (or for |
| | | user zero for MU) while 2^{nd} bit may be used for |
| | | LDPC Nsym ambiguity |
| Modulation | 4 | For MU mode, the first 3 bits may indicate |
| Coding Scheme | | coding type for users 1-3 while the last is |
| (MCS) | | reserved) |
| Beamformed | 1 | May indicate to the receiver if a beamforming |
| | | steering matrix is applied to the waveform in a |
| | | SU mode |
| Aggregation | 1 | Reserved for MU |
| Bit | | |
| Length | 9 | Length field (in symbols when aggregation is on |
| | | and in bytes when aggregation is off) May |
| | | mandate AMPDU for packet sizes >511 bytes |
| | | and for MU |
| Reserved | 4 | Doppler bit may be indicated here |
| Midamble/ | 1 | |
| Doppler | | |
| Cyclic Redun- | 4 | |
| dancy Check | | |
| Tail | 6 | May be used for BCC |

As described above, the length of the data unit may vary. Furthermore, how the value included in the length may depend on factors such as the unit of length used (e.g., bytes or symbols) as well as whether the length includes midambles and how the data unit was encoded. Because the length field may be used to calculate timing values used by a device such as transmission time, receive time, and/or deferral time, what the value included in the length field represents can impact the timing calculation. Accordingly, implementations for specifying length and the corresponding timing determinations will be described.

Although discussed as data symbols, the size of a given field of the data unit may be expressed in other terms such as bytes. In some implementations, the aggregation bit may be included in a SIG field. The aggregation bit may be used to identify data units that may be joined with other data units for transmission as a single unit. In general, when the aggregation bit is set (e.g., value of 1), symbols will be used for the data packet rather than bytes. Symbols may be used because more information can be represented using symbols as compared to bytes.

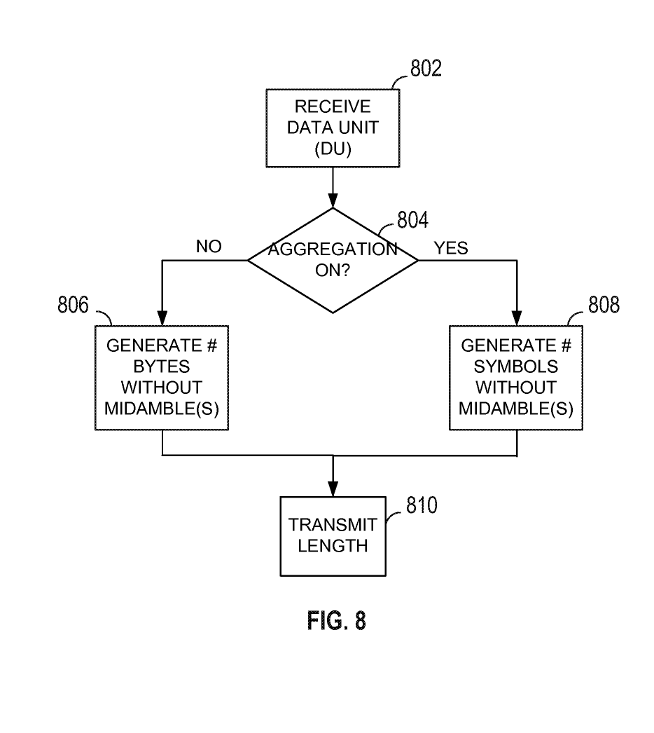

FIG. 8 illustrates a process flow diagram of one method of indicating length of a data unit. The process flow may be implemented in whole or in part with the wireless device 202 of FIG. 2. The length SIG field may include a value indicating the length of the data unit without midambles. In some implementations, this value may be referred to as the “true value.” At block 802, the data unit is received. At decision block 804, a determination is made regarding the aggregation status of the data unit. If the aggregation bit is set to the off value (e.g., 0), at block 806, a value is generated for the length field indicating the number of bytes of the data unit without midambles. In some implementations, this value may be a pre-determined value. For example, the length may be defined for the MAC interface. The length may be obtained from, for example, a memory location.

Returning to decision block 804, if the aggregation bit is set to the on value (e.g., 1), at block 808, a value is generated for the length field indicating the number of symbols (e.g., ODFM symbols) of the data unit without midambles. The generation of the length at block 808 may be based on the type of encoding used for the data unit. For example, if the data unit is encoded using binary convolution coding (BCC), the number of symbols (N_{SYM}) may be calculated using Equation 1.

$${N}_{SYM} = {m}_{STBC} \times ⌈ \frac{8 \cdot APEP\_LENGTH + {N}_{service} + {N}_{tail} \cdot {N}_{ES}}{{m}_{STBC} \cdot {N}_{DBPS}} ⌉ \qquad ( 1 )$$

where
M_{STBC} is a configurable space time block code value,
APEP_LENGTH is a configurable transmit vector length value,
N_{service} and Nₜₐᵢₗ are configurable timing values, and
N_{ES} is a configurable value indicating the number of BCC encoders for the data field, and
N_{DBPS} is a configurable value indicating a number of data bits per symbol.

In some implementations, the data unit may be encoded using low density parity checking (LDPC). In such implementations, the number of symbols may be determined using Equation 2 below.

N_{SYM}=N_{avbits}/N_{CBPS} (2)

where
N_{avbits} is a value indicating the number of available bits, and
N_{CBPS} is a value indicating the number of coded bits per symbol.

At block 810, the length value may be transmitted. The length may be transmitted, for example, to a signal processor of the device sending the data unit for inclusion in the SIG length field. In some implementations, the length may be stored in a memory location for later inclusion in the data unit.

Having thus generated a length value of the data unit, the intended user of the data unit (e.g., station to receive the data unit or access point to transmit the data unit) may use this value to determine an amount of time to transmit or receive the full packet. In some implementations this amount of time is referred to as TXTIME. In one implementation, the TXTIME may be calculated based on the duration of the guard interval for a system. The guard interval is a period of time introduced to allow discrete reception of transmitted signals and/or symbols within a signal. In some implementations, the guard interval may be a short guard interval. A short guard interval may be, for example, equal to or less than 4 microseconds. In some implementations, the short guard interval may be 4.50 or 5.13 microseconds. In an implementation including a short guard interval, the TXTIME may be calculated using Equation 3 below.

$$TXTIME = {T}_{STF} + {T}_{LTF 1} + {T}_{SIG} + {T}_{SYML} \times ⌈ \frac{{T}_{SYMS} \times {N}_{SYM}^{′}}{{T}_{SYML}} ⌉ \qquad ( 3 )$$

where
T_{sTF}, T_{LTF1}, T_{SIG}, T_{SYML}, and T_{SYMS} are pre-determined timing values, and
N′_{SYM} is a value indicating the total number of symbols including midambles as calculated by Equation 4 below.

$${N}_{SYM}^{′} = ( ⌈ \frac{{N}_{SYM}}{{N}_{d , MCS}} ⌉ - 1 ) * {N}_{midamble} + {N}_{SYM} \qquad ( 4 )$$

where
N_{d,MCS} is a value indicating the midamble frequency in symbols for the modulation coding scheme employed,
N_{SYM} is the number of symbols given by one of:
   Equation 1 above if BCC encoding; or
   Equation 2 above if LDPC encoding, and
N_{midamble} is a value indicating the number of symbols in one midamble.

In an implementation including a long guard interval, the TXTIME may be determined using Equation 5 below. A long guard interval may be 8 microseconds long. In some implementations the long guard interval may be 7.50 microseconds or 8.23 microseconds. The long guard interval is “longer” relative to the short guard interval.

TXTIME=T_{STF}+T_{LTF1}+T_{SIG}+T_{SYML}×N′_{SYM} (5)

where
T_{sTF}, T_{LTF1}, T_{SIG}, and T_{SYML} are pre-determined timing values, and
N′_{SYM} is a value indicating the total number of symbols including midambles as calculated by Equation 4 above.

As described above, multiple devices may be within a basic service area for a transmission. The devices which are not the intended recipient of a signal may nonetheless receive the transmission. In some implementations, it may be desirable for the non-intended recipient to refrain from transmitting during the exchange between the intended recipient and the transmitting device. The length included in the data unit may be used by the non-intended recipient to determine an amount of time to defer transmission. The defer time may be referred to, in some implementations, as the RXTIME.

The RXTIME may be determined in a similar fashion as TXTIME. In some implementations, the RXTIME determination may be based on the guard interval as described above. In an implementation including a short guard interval, the RXTIME may be calculated according to Equation 6.

$$RXTIME ( μ s ) = {T}_{STF} + {T}_{LTF 1} + {T}_{SIG} + {T}_{SYML} \times ⌈ \frac{{T}_{SYMS} \times {N}_{SYM}^{′}}{{T}_{SYML}} ⌉ \qquad ( 6 )$$

where
T_{sTF}, T_{LTF1}, T_{SIG}, T_{SYML}, and T_{SYMS} are pre-determined timing values, and
N′_{SYM} is a value indicating the total number of symbols including midambles, given by the Equation 7.

$${N}_{SYM}^{′} = ( ⌈ \frac{{N}_{SYM}}{{N}_{d , MCS}} ⌉ - 1 ) * {N}_{midamble} + {N}_{SYM} \qquad ( 7 )$$

where
N_{d,MCS} is a value indicating the midamble frequency in symbols for the modulation coding scheme employed,
N_{midamble} is a value indicating the number of symbols in one midamble, and
N_{SYM} is one of:
   the value included in the SIG length field if aggregation is on;
   the value of Equation 8 if aggregation is off and BCC encoding is used; or
   the value of Equation 2 if aggregation is off LDPC encoding is used.

$${N}_{SYM} = {m}_{STBC} \times ⌈ \frac{8 \cdot SIG\_Length + {N}_{service} + {N}_{tail} \cdot {N}_{ES}}{{m}_{STBC} \cdot {N}_{DBPS}} ⌉ \qquad ( 8 )$$

where
M_{STBC} is a configurable space time block code value,
SIG_LENGTH is the value included in the SIG length field,
N_{service} and Nₜₐᵢₗ are configurable timing values, and
N_{ES} is a configurable value indicating the number of BCC encoders for the data field, and
N_{DBPS} is a configurable value indicating a number of data bits per symbol.

In an implementation including a long guard interval, the RXTIME may be calculated based on Equation 9.

RXTIME(μs)=T_{STF}+T_{LTF1}+T_{SIG}+T_{SYML}×N′_{SYM} (9)

where
T_{sTF}, T_{LTF1}, T_{SIG}, and T_{SYML} are pre-determined timing values, and
N′_{SYM} is a value indicating the total number of symbols including midambles, given by the Equation 7.

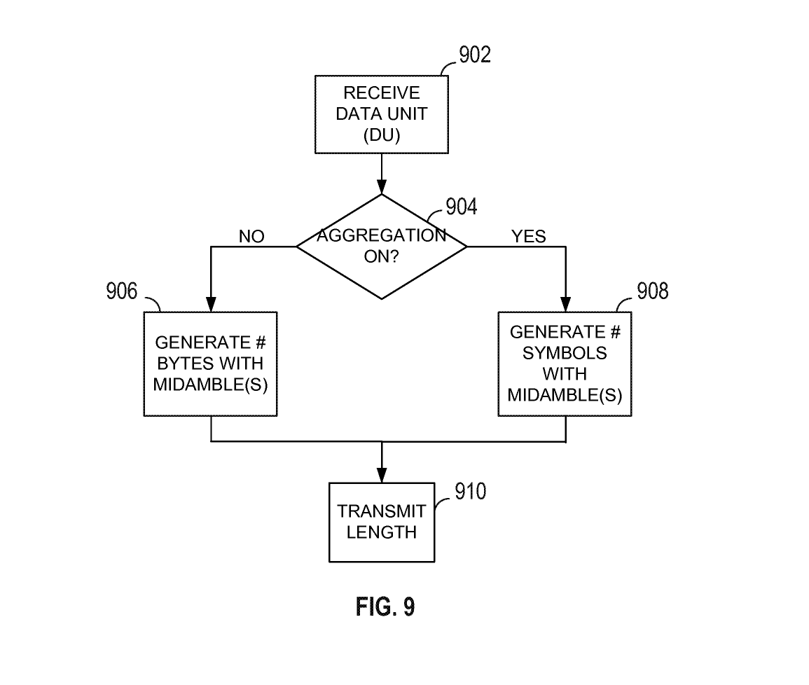

FIG. 9 illustrates a process flow diagram of another method of indicating length of a data unit. The process flow may be implemented in whole or in part with the wireless device 202 of FIG. 2. The method shown in FIG. 9 is similar to the method illustrated in FIG. 8 except that at block 906, the generation of the length for the data unit includes the length of the midamble(s) length. Similarly, at block 908, the generation of the length for the data unit includes the midamble(s) length. As described above, this value may be referred to as N′_{SYM}.

At block 908, if the aggregation bit is on, the length value may be generated using Equation 4 above. The length will indicate a number of symbols for the data unit including the midamble(s) length.

At block 906, if the aggregation bit is off, the length indication may indicate a number of bytes for the data unit including the midamble. This may be problematic for devices that do not support midambles. Non-destination STAs should be configured to disregard the information included in midambles but should be able to compute the duration required for deferral for a signal including midambles. In some implementations, the midamble interval, when represented as bytes, may be dependent on the modulation coding scheme (MCS) and bandwidth (BW) for the system. In such implementations, combinations of MCS values and BW values along with the associated midamble interval may be stored, for example, in a look up table.

In some implementations, the look up table may be generated as follows:
Let (N(BW, MCS, N(BW, MCS, i+1)) denote the range in number of bytes where i midambles are included such that i midambles are included for the packets with length L such that N(BW, MCS, i)<L<=N(BW, MCS, i+1) where L denotes the length of the MPDU in bytes.

Let M(BW, MCS) denote the number of bytes that occupy the duration of the midamble at the given MCS and BW. In some implementations M may not be an integer.

Find i such that N(BW, MCS, <L<=N(BW, MCS, i+1) where the length in the SIG length field is given by Equation 10 below.

To generate the length at block 906, some implementations may use Equation 10.

SIG_Length=L+┌M(BW,MCS)*i┐ (10)

where
L is a value indicating the length of the MAC physical data unit in bytes,
M(BW, MCS) is a value indicating the number of bytes that occupy the duration of the midamble for the given BW and MCS, and
i is a value indicating the number of midambles included for packets having length L.

At block 910, the generated value may be transmitted. The length may be transmitted, for example, to a signal processor of the device sending the data unit for inclusion in the SIG length field. In some implementations, the length may be stored in a memory location for later inclusion in the data unit.

The intended receiver may map the SIG field length indication to the byte length of the MPDU based on the indication of the presence of midambles. In some implementations, the receiver may be configured to find i such that N(BW,MCS,i)+ceil(M*i)<SIG_Length<=N(BW,MCS,i+1)+ceil(M*i). Accordingly, L may be determined by L=SIG_Length−┌(BW,MCS)*i┐.

Having thus generated a length value of the data unit, a station, such as the station intended to receive the data unit, of the data unit (e.g., station to receive the data unit) may use this value to determine an amount of time to transmit the full packet (e.g., TXTIME). In a system where aggregation is on, that is, the length field represents a number of symbols, the calculation of TXTIME may be determined based on the length. The determination may also be based on the guard interval length for the system. For example, as discussed above, a short guard interval or a long guard interval may be included. In implementations including a short guard interval, the TXTIME may be determined using Equation 3 as described above. In implementations including a long guard interval, the TXTIME may be determined using Equation 5 as described above.

In a system where aggregation is on, the RXTIME may also be determined based on the length. The determination may also be based on the guard interval for the system. In a system including a short guard interval, the RXTIME may be determined using Equation 11.

$$RXTIME ( μ s ) = {T}_{STF} + {T}_{LFT 1} + {T}_{SIG} + {T}_{SYML} \times ⌈ \frac{{T}_{SYMS} \times SIG\_Length}{{T}_{SYML}} ⌉ \qquad ( 11 )$$

where
T_{sTF}, T_{LTF1}, T_{SIG}, T_{SYML}, and T_{SYMS} are pre-determined timing values, and
SIG_LENGTH is the value included in the SIG length field.

In systems which include a long guard interval, the RXTIME may be determined using Equation 12.

RXTIME(μs)=T_{STF}+T_{LFT1}+T_{SIG}+T_{SYML}×SIG_Length (12)

where
T_{sTF}, T_{LTF1}, T_{SIG}, T_{SYML}, and T_{SYMS} are pre-determined timing values, and
SIG_Length is the value included in the SIG length field.

Following the training and signal fields, the coded PSDU (C-PSDU) field may be received. The C-PSDU field may include the coded PLCP SERVICE field and a scrambled and coded PSDU. The number of symbols in the C-PSDU may be determined in part based on N_{SYM} using Equation 13 below.

$$SIG\_Length ( ⌈ \frac{{N}_{SYM}}{{N}_{d , MCS}} ⌉ - 1 ) * {N}_{midamble} + {N}_{SYM} \qquad ( 13 )$$

where
N_{d,MCS} is a value indicating the midamble frequency in symbols for the modulation coding scheme employed,
N_{midamble} is a value indicating the number of symbols in one midamble, and
N_{SYM} is a value indicating the number of symbols in the coded PSDU which may be stored in a look up table.

In a system where the aggregation bit is off, that is, the length value may represent the number of bytes for the data unit inclusive of the midamble(s), TXTIME may be determined using Equation 3 as described above for short guard interval systems. The TXTIME may be determined using Equation 5 as described above for long guard interval systems.

In implementations where aggregation is off, that is the length value represents the number of bytes for the data unit inclusive of the midamble(s), RXTIME may be determined based on Equation 14 for short guard interval implementations.

$$RXTIME ( μ s ) = {T}_{STF} + {T}_{LFT 1} + {T}_{SIG} + {T}_{SYML} \times ⌈ \frac{{T}_{SYMS} \times {N}_{SYM}^{′}}{{T}_{SYML}} ⌉ \qquad ( 14 )$$

where
T_{sTF}, T_{LTF1}, T_{SIG}, T_{SYML}, and T_{SYMS} are pre-determined timing values, and
N′_{SYM} is a value indicating the total number of symbols including midambles, given by the Equation 15.

$${N}_{SYM}^{′} = ( ⌈ \frac{{N}_{SYM}}{{N}_{d , MCS}} ⌉ - 1 ) * {N}_{midamble} + {N}_{SYM} \qquad ( 15 )$$

where
N_{d,MCS} is a value indicating the midamble frequency in symbols for the modulation coding scheme employed,
N_{midamble} is a value indicating the number of symbols in one midamble, and
N_{SYM} is one of:
   the value of Equation 16 if BCC encoding is used; or
   the value of Equation 2 if LDPC encoding is used.

$${N}_{SYM} = {m}_{STBC} \times ⌈ \frac{8 \cdot L + {N}_{service} + {N}_{tail} \cdot {N}_{ES}}{{m}_{STBC} \cdot {N}_{DBPS}} ⌉ \qquad ( 16 )$$

where
m_{STBC} is a configurable space time block code value,
L is a value indicating the length of the MAC physical data unit in bytes,
N_{service} and Nₜₐᵢₗ are configurable timing values,
N_{ES} is a configurable value indicating the number of BCC encoders for the data field, and
N_{DBPS} is a configurable value indicating a number of data bits per symbol.

As discussed above, L may be obtained from a look up table based at least in part on the modulation coding scheme and bandwidth associated with the data unit. In some implementations, the modulation coding scheme and bandwidth information may be a network-wide configuration.

In implementations where aggregation is off, that is the length value represents the number of bytes for the data unit inclusive of the midamble(s), RXTIME may be determined based on Equation 17 for long guard interval implementations.

RXTIME(μs)=T_{STF}+T_{LTF1}+T_{SIG}+T_{SYML}×N′_{SYM} (17)

where
T_{STF}, T_{LTF1}, T_{SIG}, and T_{SYML} are pre-determined timing values, and
N′_{SYM} is a value indicating the total number of data symbols inclusive of midambles for the data unit given by Equation 15.

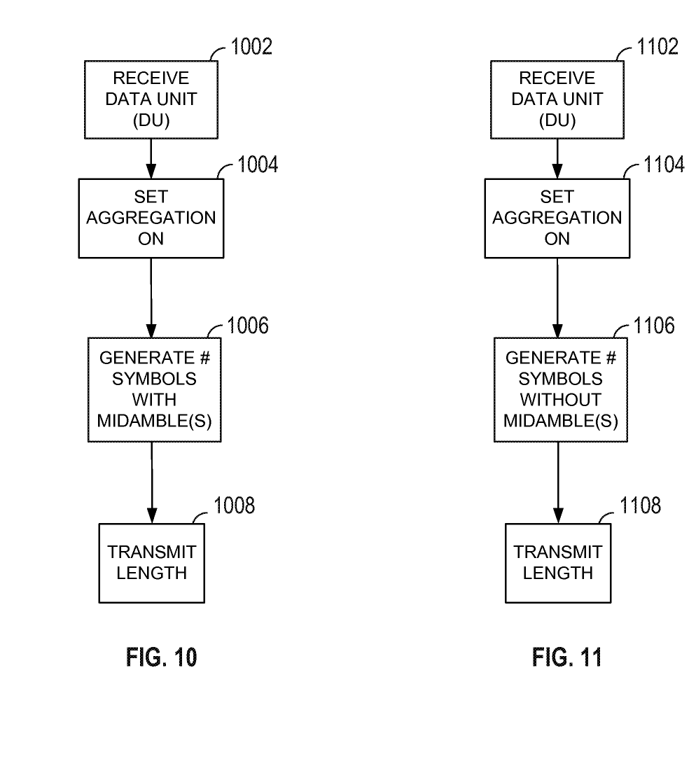

FIG. 10 illustrates a process flow diagram of a further method of indicating length of a data unit. The process flow may be implemented in whole or in part with the wireless device 202 of FIG. 2. At block 1002, a data unit may be received. At block 1004, the aggregation bit may be set to on (e.g., a value of 1). In some implementations, setting the aggregation bit to “on” indicates that the data unit will be represented using symbols. Although the aggregation bit is described in reference to FIG. 10 and above as signifying whether the data unit is represented as bytes or symbols, other fields or values may be used to achieve a similar indication. Accordingly, setting aggregation to on may be understood as setting a value indicating the information included in the data unit is represented in symbols.

In setting the aggregation bit, block 1004 may also include setting a value indicating the presence of a midamble. For example, a midamble present SIG field may be set to an on value (e.g., 1) to indicate the presence of midambles in the associated data unit. Including this value may be desirable to allow stations that support midambles to efficiently determine the position of the midambles based on, for example, the modulation coding scheme.

At block 1006, a value indicating the number of symbols for the data unit inclusive of midamble(s) (N′_{SYM}) may be generated. In some implementations, the length may be generated based on Equation 4 above. At block 1008, the length value may be transmitted as described above, such as in reference to FIG. 8.

As discussed, the generated length value may be transmitted in the data unit such as in a SIG length field. A station receiving the data unit may be configured to obtain the length information. The length information may be used to determine subsequent signal processing characteristics such as the length of the data unit, TXTIME, or RXTIME.

The value of TXTIME may be determined from the generated and transmitted length value based in part on the guard interval for the system. Short and long guard intervals are described above. If the system is configured to include short guard intervals, the TXTIME may be determined based on Equation 3 above. If the system is configured to include long guard intervals, the TXTIME may be determined based on Equation 5 above.

The value of RXTIME may be determined from the generated and transmitted length value based in part on the guard interval for the system. Short and long guard intervals are described above. If the system is configured to include short guard intervals, the RXTIME may be determined based on Equation 11 above. If the system is configured to include long guard intervals, the RXTIME may be determined based on Equation 12 above.

FIG. 11 illustrates a process flow diagram of another method of indicating length of a data unit. The process flow may be implemented in whole or in part with the wireless device 202 of FIG. 2. At block 1102, a data unit is received. At block 1104, the aggregation bit is set to on (e.g., a value of 1). At block 1106, a value indicating the number of symbols for the data unit excluding midamble(s) (N_{SYM}) may be generated.

The generation of the length at block 808 may be based on the type of encoding used for the data unit. For example, if the data unit is encoded using binary convolution coding (BCC), the number of symbols (N_{SYM}) may be calculated using Equation 1 as described above. In some implementations, low parity density bit encoding may be used to encode the data unit. In such implementations, the number of symbols may be generated using Equation 2 as described above.

At block 1008, the length value may be transmitted as described above, such as in reference to FIG. 8.

As discussed, the generated length value may be transmitted in the data unit such as in a SIG length field. A station receiving the data unit may be configured to obtain the length information. The length information may be used to determine subsequent signal processing characteristics such as the length of the data unit, TXTIME, or RXTIME.

The value of TXTIME may be determined from the generated and transmitted length value based in part on the guard interval for the system. Short and long guard intervals are described above. If the system is configured to include short guard intervals, the TXTIME may be determined based on Equation 3 above. If the system is configured to include long guard intervals, the TXTIME may be determined based on Equation 5 above.

The value of RXTIME may be determined from the generated and transmitted length value based in part on the guard interval for the system. Short and long guard intervals are described above. If the system is configured to include short guard intervals, the RXTIME may be determined based on, for example, Equation 6, 11, or 14 above. If the system is configured to include long guard intervals, the RXTIME may be determined based on, for example, Equation 9, 12, or 17 above.

In the implementations described above, such as FIG. 8, 9, 10, or 11, for Doppler-incapable stations (e.g., stations which disregard midamble(s)), the station deferral may be configured to use the RXTIME to generate a duration value indicating the amount of time to defer transmission. In some implementations, the deferral duration (SIG_Duration) may be generated using Equation 18.

SIG_Duration=RXTIME(μs)−T_{STF}−T_{LFT1}−T_{SIG} (18)

where
RXTIME(μs) is the RXTIME from given by one of:
   Equation 6, 11, or 14 for short guard interval systems, or
   Equation 9, 12, or 17 for long guard interval systems; and
T_{sTF}, T_{LTF1}, and T_{sIG} are pre-determined timing values.

Several parameters have been included above as examples of values that may be included in one or more aspects of the system. The parameters may be stored in a memory of a communication device. The parameters may be calculated or derived from a stored value. Table 1 below provides a summary of several parameters that may be included.

TABLE 1

| Symbol | Explanation |
|---|---|
| N_{CBPS} | Number of coded bits per symbol |
| N_{CBPSS}(i) | Number of coded bits per symbol per the i-th spatial stream |
| N_{DBPS} | Number of data bits per symbol |
| N_{BPSC} | Number of coded bits per single carrier |
| N_{BPSCS}(i) | Number of coded bits per single carrier for spatial stream i |
| N_{RX} | Number of receive chains |
| N_{STS} | Number of space-time streams |
| N_{SS} | Number of spatial streams |
| N_{ESS} | Number of extension spatial streams |
| N_{TX} | Number of transmit chains |
| N_{ES} | Number of BCC encoders for the Data field |
| N_{HTLTF} | Number of HT Long Training fields |
| N_{HTDLTF} | Number of Data HT Long Training fields |
| N_{HTELTF} | Number of Extension HT Long Training fields |
| R | Coding rate |

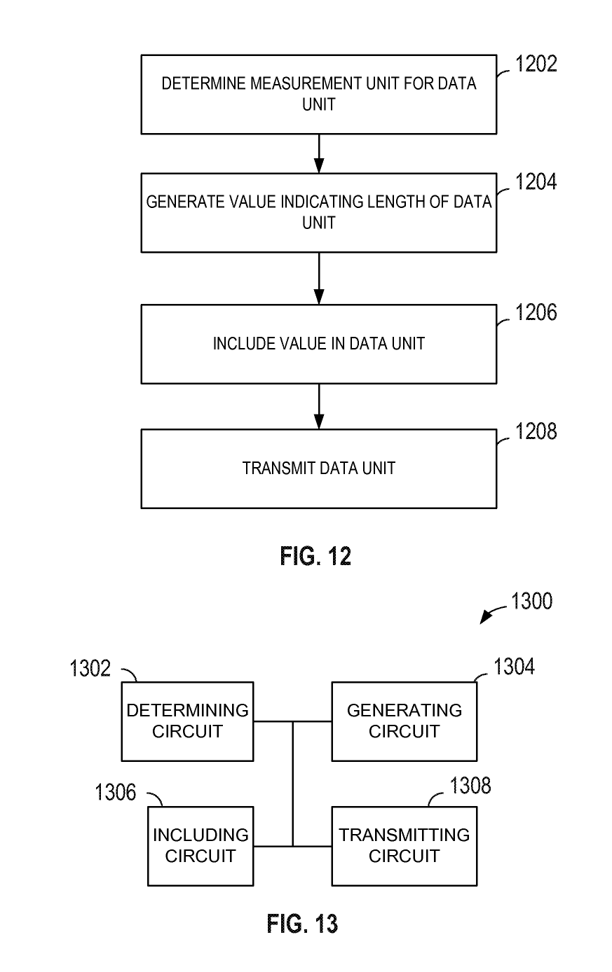

FIG. 12 is a process flow diagram illustrating a method of communicating in a wireless communication system. The method may be implemented in one or more of the devices described herein, such as the wireless device 202. The method described in FIG. 12 may further include aspects of the processes described above, such as in FIGS. 8, 9, 10, and 11.

At block 1202, a measurement unit for the data unit is determined. The data unit may include a midamble. The measurement unit indicates the unit of length used to identify the length of the data unit. The measurement unit may be bytes or symbols (e.g., OFDM symbols). As described above, the aggregation bit may be used to determine the measurement unit.

At block 1204, a value indicating the length of the data unit may be generated. The length value may be generated based at least in part on the measurement unit, an encoding scheme associated with the data unit, and a guard interval associated with the data unit. Generating the length may include calculating the length value as described above.

At block 1206, the generated value may be included in the data unit. For example, the generated value may be included a signal (SIG) length field of the data unit. At block 1208, the data unit may be transmitted to one or more devices.

FIG. 13 illustrates a functional block diagram of an example wireless device. The wireless device 1300 may implement all or part of one or more of the processes described above such as that in FIG. 8, 9, 10, 11, or 12. Those skilled in the art will appreciate that a wireless device may have more components than the simplified wireless device 1300 shown in FIG. 13. The wireless device 1300 shown includes only those components useful for describing some prominent features of certain implementations. The wireless device 1300 includes a determining circuit 1320, a generating circuit 1304, an including circuit 1306, and a transmitting circuit 1308.

In some implementations, the determining circuit 1302 is configured to determine a measurement unit for representing the length of a data unit. The determining circuit 1302 may include a processor, a memory, and a signal processor. In some implementations, the means for determining may include the determining circuit 1302.

In some implementations, the generating circuit 1304 is configured to generate a value indicating the length of the data unit based at least in part on the measurement unit and an encoding scheme associated with the data unit. The generating circuit 1304 may include a processor, a memory, an arithmetic unit, and a signal generator. In some implementations, the means for generating may include the generating circuit 1304.

In some implementations, the including circuit 1306 is configured to include the generated value in the data unit. The including circuit 1306 may include a processor, a memory, an arithmetic unit, and a data unit generator. In some implementations, the means for including may include the including circuit 1306.

In some implementations, the transmitting circuit 1308 is configured to transmit via wireless network the data unit to one or more devices. The transmitting circuit 1308 may include a processor, a memory, a transmitter, and an antenna. In some implementations, the means for transmitting may include the transmitting circuit 1308.

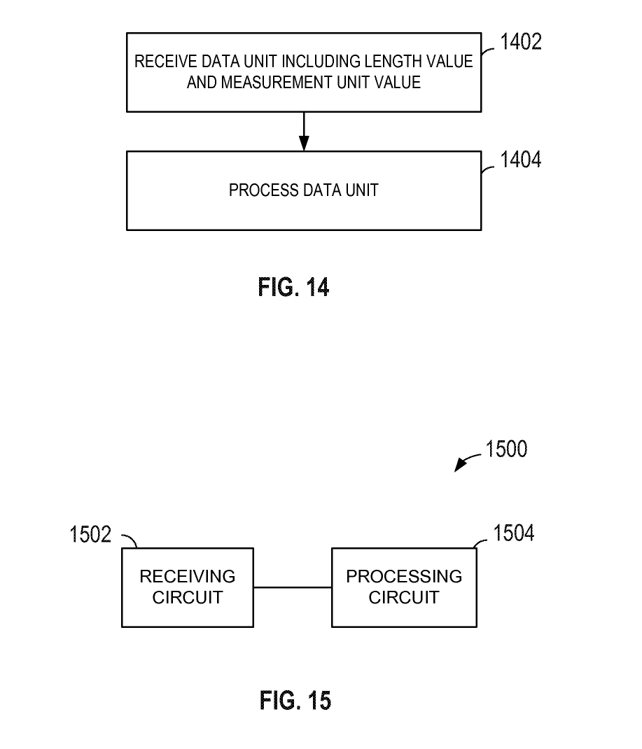

FIG. 14 is a process flow diagram illustrating a method of communicating in a wireless communication system. The method may be implemented in one or more of the devices described herein, such as the wireless device 202. The method described in FIG. 14 may further include aspects of the processes described above, such as in FIGS. 8, 9, 10, 11, and 12.

At block 1402, a data unit is received. The data unit may be received via wireless network. The data unit may include a midamble, a first value indicating a measurement unit for representing the length of the data unit, and a second value indicating a length for the data unit.

At block 1404, the data unit may be processed based at least in part on the first value, the second value, and an encoding scheme associated with the data unit. The processing may include determining a transmit time (e.g., quantity of time to transmit the data unit, absolute transmission time, or relative transmission time), a receive time (e.g., quantity of time to receive the data unit, absolute reception time, or relative reception time), or a deferral time as described above.

FIG. 15 illustrates a functional block diagram of another example wireless device. The wireless device 1500 may implement all or part of one or more of the processes described above such as that in FIG. 8, 9, 10, 11, 12, or 14. Those skilled in the art will appreciate that a wireless device may have more components than the simplified wireless device 1500 shown in FIG. 15. The wireless device 1500 shown includes only those components useful for describing some prominent features of certain implementations. The wireless device 1500 includes a receiving circuit 1520, and a processing circuit 1504.

In some implementations, the receiving circuit 1502 is configured to receive via wireless network a data unit including a midamble, a first value indicating a measurement unit for representing the length of the data unit, and a second value indicating a length for the data unit. The receiving circuit 1502 may include a processor, a memory, a signal processor, and an antenna. In some implementations, the means for receiving may include the receiving circuit 1502.

In some implementations, the processing circuit 1504 is configured to process the data unit based at least in part on the first value, the second value, and an encoding scheme associated with the data unit. The processing circuit 1504 may include a processor, a memory, a signal processor, a transmission controller, and a transmitter. In some implementations, the means for processing may include the processing circuit 1504.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for wireless communication, comprising:
determining, with a processor, a measurement unit for representing the length of a data unit, the data unit including a midamble, the measurement unit being at least one of bytes or symbols;
generating a value indicating the length of the data unit based at least in part on the measurement unit and an encoding scheme associated with the data unit;
including the generated value in the data unit; and
transmitting via wireless network the data unit to one or more devices.

2. The method of claim 1, wherein generating the value is based on timing information associated with the wireless network.

3. The method of claim 1, wherein generating the value is based on encoding stream information associated for the wireless network.

4. The method of claim 1, wherein generating the value is based on a relationship between data bits and symbols for the wireless network.

5. The method of claim 1, wherein the encoding scheme comprises at least one of block convolution coding and low-density parity check coding.

6. The method of claim 1, wherein generating the value comprises obtaining a stored value from a memory, the generating based at least in part on the stored value.

7. The method of claim 6, wherein obtaining the stored value is based at least in part on a modulation coding scheme associated with the wireless network.

8. The method of claim 6, wherein obtaining the stored value is based at least in part on a bandwidth associated with the wireless network.

9. The method of claim 1, wherein the data unit comprises a physical layer protocol data unit (PPDU).

10. The method of claim 1, wherein including the value comprises setting a second value for a signal length field to the value.

11. The method of claim 1, wherein determining the measurement unit is based at least in part on information included in the data unit.

12. The method of claim 11, wherein the information included in the data unit includes aggregation information.

13. The method of claim 1, comprising setting a second value for the measurement unit for the data unit to a third value indicating symbols as the measurement unit.

14. A method for wireless communication, comprising:
receiving via wireless network a data unit including a midamble, a first value indicating a measurement unit for representing the length of the data unit, and a second value indicating a length for the data unit; and
processing the data unit based at least in part on the first value, the second value, and an encoding scheme associated with the data unit.

15. The method of claim 14, wherein the measurement unit indicates one of bytes or symbols.

16. The method of claim 14, wherein the first value is included an aggregation on field of the data unit.

17. The method of claim 14, wherein the second value is included in a signal length field of the data unit.

18. The method of claim 14, wherein processing the data unit comprises generating a transmit time indicating a quantity of time for transmitting the data unit.

19. The method of claim 18, wherein the transmit time is generated based at least in part on timing information associated with the wireless network.

20. The method of claim 18, wherein the transmit time is generated based at least in part on a guard interval associated with the wireless network.

21. The method of claim 18, wherein the transmit time is generated based at least in part on a modulation coding scheme associated with the wireless network.

22. The method of claim 14, wherein processing the data unit comprises generating a receive time indicating a quantity of time reserved for transmitting the data unit.

23. The method of claim 22, comprising buffering of transmission of signals during the receive time.

24. The method of claim 22, wherein the receive time is generated based at least in part on timing information associated with the wireless network.

25. The method of claim 22, wherein the receive time is generated based at least in part on a guard interval associated with the wireless network.

26. The method of claim 22, wherein the receive time is generated based at least in part on a modulation coding scheme associated with the wireless network.

27. An apparatus for wireless communication, comprising:
a determining circuit configured to determine a measurement unit for representing the length of a data unit, the data unit including a midamble, the measurement unit being at least one of bytes or symbols;
a length generator circuit configured to generate a value indicating the length of the data unit based at least in part on the unit and an encoding scheme associated with the data unit;
a data unit generator circuit configured to include the generated value in the data unit; and
a transmitter configured to transmit via wireless network the data unit to one or more devices.

28. The apparatus of claim 27, wherein generating the value is based on timing information associated with the wireless network.

29. The apparatus of claim 27, wherein generating the value is based on encoding stream information associated for the wireless network.

30. The apparatus of claim 27, wherein generating the value is based on a relationship between data bits and symbols for the wireless network.

31. The method of claim 27, wherein the encoding scheme comprises at least one of block convolution coding and low-density parity check coding.

32. The apparatus of claim 27, comprising a memory, wherein generating the value comprises obtaining a stored value from the memory, the generating based at least in part on the stored value.

33. The apparatus of claim 32, wherein obtaining the stored value is based at least in part on a modulation coding scheme associated with the wireless network.

34. The apparatus of claim 32, wherein obtaining the stored value is based at least in part on a bandwidth associated with the wireless network.

35. The apparatus of claim 27, wherein the data unit comprises a physical layer protocol data unit (PPDU).

36. The apparatus of claim 27, wherein including the value comprises setting a second value for a signal length field to the value.

37. The apparatus of claim 27, wherein determining the measurement unit is based at least in part on information included in the data unit.

38. The apparatus of claim 37, wherein the information included in the data unit includes aggregation information.

39. The apparatus of claim 27, comprising setting a second value for the measurement unit for the data unit to a third value indicating symbols as the measurement unit.

40. An apparatus for wireless communication, comprising:
a receiver configured to receive via wireless network a data unit including a midamble, a first value indicating a measurement unit for representing the length of the data unit, and a second value indicating a length for the data unit; and
a processor configured process the data unit based at least in part on the first value, the second value, and an encoding scheme associated with the data unit.

41. The apparatus of claim 40, wherein the measurement unit indicates one of bytes or symbols.

42. The apparatus of claim 40, wherein the first value is included an aggregation on field of the data unit.

43. The apparatus of claim 40, wherein the second value is included in a signal length field of the data unit.

44. The apparatus of claim 40, wherein processing the data unit comprises generating a transmit time indicating a quantity of time for transmitting the data unit.

45. The apparatus of claim 44, wherein the transmit time is generated based at least in part on timing information associated with the wireless network.

46. The apparatus of claim 44, wherein the transmit time is generated based at least in part on a guard interval associated with the wireless network.

47. The apparatus of claim 44, wherein the transmit time is generated based at least in part on a modulation coding scheme associated with the wireless network.

48. The apparatus of claim 40, wherein processing the data unit comprises generating a receive time indicating a quantity of time reserved for transmitting the data unit.

49. The apparatus of claim 48, comprising buffering of transmission of signals during the receive time.

50. The apparatus of claim 48, wherein the receive time is generated based at least in part on timing information associated with the wireless network.

51. The apparatus of claim 48, wherein the receive time is generated based at least in part on a guard interval associated with the wireless network.

52. The apparatus of claim 48, wherein the receive time is generated based at least in part on a modulation coding scheme associated with the wireless network.

53. An apparatus for wireless communication, comprising:
means for determining a measurement unit for representing the length of a data unit, the data unit including a midamble, the measurement unit being at least one of bytes or symbols;
means for generating a value indicating the length of the data unit based at least in part on the measurement unit and an encoding scheme associated with the data unit;
means for including the generated value in the data unit; and
means for transmitting via wireless network the data unit to one or more devices.

54. An apparatus for wireless communication, comprising:
means for receiving via wireless network a data unit including a midamble, a first value indicating a measurement unit for representing the length of the data unit, and a second value indicating a length for the data unit; and
means for processing the data unit based at least in part on the first value, the second value, and an encoding scheme associated with the data unit.

55. A computer-readable storage medium including instructions executable by a processor of an apparatus, the instructions causing the apparatus to:
determine a measurement unit for representing the length of a data unit, the data unit including a midamble, the measurement unit being at least one of bytes or symbols;
generate a value indicating the length of the data unit based at least in part on the measurement unit and an encoding scheme associated with the data unit;
include the generated value in the data unit; and
transmit via wireless network the data unit to one or more devices.

56. A computer-readable storage medium including instructions executable by a processor of an apparatus, the instructions causing the apparatus to:
receive via wireless network a data unit including a midamble, a first value indicating a measurement unit for representing the length of the data unit, and a second value indicating a length for the data unit; and
process the data unit based at least in part on the first value, the second value, and an encoding scheme associated with the data unit.
